(19) United States
(12) Patent Application Publication
(10) Pub. No.: US 2024/0377135 A1
(43) Pub. Date: Nov. 14, 2024

(54) DRYING DEVICE AND METHOD FOR FORMING A COATING IN THE CAVITY OF A METAL CAN

(71) Applicant: BELVAC PRODUCTION MACHINERY, INC., Lynchburg, VA (US)

(72) Inventor: Ulf REINHARDT, Teutschenthal (DE)

(21) Appl. No.: 18/687,910

(22) PCT Filed: Aug. 24, 2022
(86) PCT No.: PCT/DE2022/100636

§ 371 Date: Feb. 29, 2024

(30) Foreign Application Priority Data
Sep. 1, 2021 (DE) 10 2021 122 600.7

(51) Int. Cl. F26B 21/06; F26B 23/00

(52) U.S. Cl. CPC F26B 21/06; F26B 23/002

(57) ABSTRACT

The invention relates to a drying device for forming a coating with at least one defined coating parameter in the cavity of a metal can, including a drying chamber through which the cans can be moved; adjustment means which have two or more controllable adjustment variables, wherein the adjustment means are arranged and designed so as to adjust the at least one coating parameter of the coating; and a controller, which is coupled to the adjustment means so as to transmit signals and which is designed to control the two or more adjustment variables on the basis of at least one can parameter such that the coating is formed with the at least one defined coating parameter.

### CROSS-REFERENCE TO RELATED APPLICATIONS

This application is a U.S. national stage of International Application No. PCT/DE2022/100636, filed Aug. 24, 2022, which claims the benefit of and priority to German Patent Application No. 10 2021 122 600.7, filed Sep. 1, 2021, each of which is hereby incorporated by reference herein in its entirety.

### FIELD

The invention relates to a drying device, in particular an interior dryer, and a method for forming a coating with at least one defined coating parameter in a cavity of a metal can, in particular a beverage or food can.

### BACKGROUND

Drying devices for forming a coating in a cavity of a metal can are generally known. Such drying devices are also known as internal dryers or internal baking ovens, also known as IBOs. In a process step before the drying device, a lacquer is applied to the interior wall forming the cavity. This lacquer is dried and/or polymerized in the drying device. To do this, the cans are moved through the drying device while hot air is applied to them.

The quality of the coating has an influence on the area of application of the can and on the shelf life of the food stored in the can. In particular, foods with a high mineral content chemically attack the coating, so that high demands are placed on the quality of the coating.

When operating such drying devices, various parameters that influence the quality of the coating are adjusted manually. This adjustment is made during operation of the drying device and is largely dependent on the operator's experience.

DE 27 22 999 A1 and EP 0 072 638 A1 disclose devices and methods for drying cans, but practice shows that such devices and methods are not suitable for forming a high-quality coating.

It is an industry requirement to be able to operate such drying equipment as independently as possible of the experience of individual operators. Another aim is to produce a consistent quality of coating in the cavities of the cans, even though different types of cans are regularly produced with the drying device.

It is therefore a task of the invention to provide a drying device and a method for forming a coating with at least one defined coating parameter in a cavity of a metal can, which reduce or eliminate one or more of the disadvantages mentioned. In particular, it is a task of the invention to provide a solution that enables a high-quality coating in a cavity of a metal can.

### SUMMARY

According to one embodiment, a drying apparatus for forming a coating with at least one defined coating parameter in a cavity of a metallic can is disclosed, the drying device comprises a drying chamber through which the cans can be moved. The drying device further comprises adjustment means having two or more controllable adjustment variables, wherein the adjustment means are arranged and adapted to adjust the at least one coating parameter of the coating. The drying device further comprises a control unit which is coupled to the adjustment means so as to transmit signals and which is set up to control the two or more adjustment variables as a function of at least one can parameter in such a way that the coating is formed with the at least one defined coating parameter.

### BRIEF DESCRIPTION OF THE DRAWINGS

Preferred embodiments are explained by way of example with reference to the enclosed figures. It shows:

FIG. 1: a schematic, two-dimensional side view of an exemplary embodiment of a drying device;

FIG. 2: a schematic, two-dimensional cross-sectional view of the drying device shown in FIG. 1;

FIG. 3: a schematic view of data processing; and

FIG. 4: a schematic view of an exemplary embodiment of a method.

In the figures, identical or essentially functionally identical or similar elements are designated with the same reference symbols.

### DETAILED DESCRIPTION

Existing problems in the art are solved with a drying device and a method according to the features of the independent patent claims. Further advantageous embodiments of these aspects are indicated in the respective dependent patent claims. The features listed individually in the patent claims and the description can be combined with one another in any technologically meaningful way, whereby further embodiments of the invention are shown.

According to a first aspect, the task mentioned at the beginning is solved by a drying device, in particular an interior dryer for forming a coating with at least one defined coating parameter in a cavity of a metal can, in particular a beverage or food can, comprising a drying chamber through which the cans can be moved, adjustment means with two or more controllable adjustment variables, wherein the adjustment means are arranged and designed to adjust the at least one coating parameter of the coating, and a control unit which is coupled to the adjustment means so as to transmit signals and is set up to control the two or more adjustment variables as a function of at least one can parameter in such a way that the coating is formed with the at least one defined coating parameter.

The invention is based on the finding that the quality of the coating in the cavity of metal cans is dependent on adjustment variables that differ for different types of cans and/or lacquers. For example, a tall and slim can requires different adjustments, such as fluid flows and temperatures, than a wide and low can. Furthermore, different lacquers can be used for which different controlled or adjusted adjustments are required to adjust a coating parameter.

The inventor has also discovered that an automated adjustment of the adjustment variables depending on the can type or a can parameter of the can enables a high quality of the coating. Thus, for example, the adjustment values of the adjustment variables can be stored for each can type in the control unit or a memory unit, which is explained in more detail below, such that the optimum adjustment values of the adjustment variables can be adjusted immediately after a can type has been changed.

The coating in the cavity of metal cans is formed by the drying device by forming the lacquer applied in the previous step into the coating by drying and polymerization.

The drying device comprises the drying chamber through which the cans can be moved. The drying chamber preferably comprises an inlet side and an outlet side. The drying chamber preferably has a chamber inlet on the inlet side for the cans to enter and a chamber outlet on the outlet side for the cans to exit. It is preferred that the drying device has a conveyor device described in more detail below. The cans are conveyed between the chamber inlet and the chamber outlet by a conveyor belt of the conveyor device, for example. The conveyor belt is usually fluid-permeable. The cans are usually exposed to a hot drying fluid from above, which then passes through the conveyor belt and is fed from there to either an air circulation and/or an exhaust air system. Furthermore, the drying chamber can have different flow media in order to ensure that the cans are exposed to the drying fluid as evenly as possible.

In addition, the drying chamber preferably has one, two or more fluid supply lines, which are fluidically coupled in particular to a fluid flow device, which is explained in more detail below. It is also preferable for the drying chamber to be essentially fluid-tight, for example by means of a chamber wall.

Furthermore, the drying device comprises the adjustment means with two or more controllable adjustment variables. The adjustment means can, for example, be a fluid flow device for applying a drying fluid to the cans, whereby the adjustment variables can be a temperature of the drying fluid and a fluid flow of the drying fluid. In addition, the adjustment means can be designed as or comprise a conveyor belt and one of the two or more controllable adjustment variables can be a conveyor speed of the conveyor belt.

The adjustment means are arranged and designed to adjust the at least one coating parameter of the coating. The coating parameter of the coating is adjusted with the adjustment means, among other things, by the adjustment means acting on the coating. This can be done, for example, with the drying fluid mentioned above. The adjustment means are preferably arranged to act in the drying chamber.

The drying device also comprises the control unit, which is coupled to the adjustment means so as to transmit signals. The control unit is set up to control the two or more adjustment variables as a function of at least one can parameter in such a way that the coating is formed with the at least one defined coating parameter. A correlation between the two or more adjustment variables, the at least one can parameter and the coating parameter that can be achieved with this combination can be determined, for example, by means of tests.

The fact that the two or more adjustment variables are controlled can also mean that the two or more adjustment means are adjusted and/or regulated. The can parameter can describe the can type, for example. As explained in more detail below, the can parameter can be a can volume or a can height.

The coating parameter can be a constant. The coating parameter can be a pore density. The pore density of such cans is usually determined by measuring the resistance of the coated cans using an electrolyte by measuring the current flow over a certain period of time.

A preferred embodiment of the drying device comprises a memory unit coupled to the control unit, in which an adjustment value for at least one defined can parameter for adjusting the at least one coating parameter is stored for each of the two or more adjustment variables, and wherein the control unit is arranged to adjust the respective one adjustment value for the two or more adjustment variables when a can is produced with the at least one defined can parameter.

The adjustment value can also be an adjustment range. It is particularly preferred that adjustment values for the two or more adjustment variables are stored in the memory unit for different defined can parameters. For example, a first set of adjustment values for the adjustment variables can be provided for a 0.5 liter can and another set of adjustment values for the two or more adjustment variables can be provided for a can with a volume of 0.33 liters.

The memory unit can be integrated with the control unit. In addition, the memory unit can be arranged separately from the control unit. A separate arrangement can also be an arrangement spaced apart from the drying device as such. For example, the control unit can be linked to the memory unit by means of a data connection, for example via the Internet.

The can parameter is usually made available to the control unit. This can be done, for example, by a production machine upstream of the drying device. In addition, a central control unit can be provided, which supplies the can parameters to the control unit.

In the event that the control unit is informed that cans are being produced with the at least one defined can parameter, the control unit immediately adjusts the adjustment values for the two or more adjustment variables so that the coating is produced with the at least one coating parameter.

A further preferred embodiment of the drying device is characterized in that the adjustment means comprise or are a fluid flow device for applying a drying fluid to the cans, and the fluid flow device can be controlled by at least one of the two or more adjustment variables.

The fluid flow device preferably comprises a plurality and/or all of the units of the drying device, which are arranged and designed to apply the drying fluid to the cans. Parts of the fluid flow device can be, for example, exhaust air and circulating air fans, air flow flaps, heating units and other units acting on the drying fluid.

A further preferred embodiment of the drying device is characterized in that the fluid flow device has a height-adjustable nozzle unit, wherein one of the two or more adjustment variables is a position of the nozzle unit, such that a clear height between the nozzle unit, in particular a nozzle outlet, and the cans, in particular a can top edge, can be adjusted. The nozzle unit is height-adjustable, particularly in the vertical direction. In particular, the nozzle unit is arranged above a conveyor belt with which the cans are moved through the drying chamber and is height-adjustable.

The nozzle unit preferably comprises two or more nozzles. The nozzles preferably extend from a nozzle inlet to a nozzle outlet. In normal operation, the nozzles preferably have an essentially vertically aligned passage axis. Furthermore, the nozzle outlet preferably faces the cans during intended operation.

The height of the nozzle unit, in particular the nozzle outlets, has an effect on the quality of the coating. As a result, it is advantageous to make the nozzle unit height-adjustable in order to form the coating with the at least one defined coating parameter. The nozzle unit preferably comprises a large number of individual nozzles. The nozzle unit can be designed as a nozzle plate, for example. It is also preferable that the nozzle unit is arranged between the cans and a perforated plate for distributing the drying fluid during normal operation. The nozzle unit is also preferably arranged and designed so that the drying fluid emerging from the nozzle unit is directed towards the cans.

A further preferred embodiment of the drying device comprises a nozzle actuator coupled to the nozzle unit, which is arranged and designed to adjust the position of the nozzle unit, in particular in the vertical direction. The nozzle actuator is also preferably coupled to the control unit so as to transmit signals, such that the nozzle actuator can be controlled by the control unit.

A further preferred embodiment of the drying device is characterized in that one of the two or more adjustment variables is a drying fluid speed of the drying fluid flowing out of the nozzle unit. The drying fluid speed can be controlled, for example, with a recirculation fan or an exhaust fan described below.

In particular, the nozzle unit is designed to apply the drying fluid directly to the cans. The drying fluid speed has an influence on the coating of the cans, as these fluid movements of the drying fluid within the cavity of the cans affect the quality of the coating.

A further preferred embodiment of the drying device comprises at least one pressure loss sensor for determining a pressure loss between a nozzle inlet and a nozzle outlet of the nozzle unit in order to determine the drying fluid speed.

Preferably, the nozzle unit has the pressure loss sensor. The pressure loss sensor is preferably coupled to the control unit so as to transmit signals. The control unit is also preferably set up to determine the drying fluid speed on the basis of the pressure loss.

A further preferred embodiment of the drying device comprises a recirculating air circuit for recirculating the drying fluid in the drying chamber with a recirculating air flap coupled to a recirculating air actuator, wherein one of the two or more adjustment variables is a position of the recirculating air flap.

The fluid flow device preferably comprises the air recirculation circuit, the air recirculation flap and/or the air recirculation actuator. The air recirculation actuator is preferably signal-coupled with the control device for adjusting the air recirculation flap. The position of the recirculation flap can, for example, be an opening degree between 0% and 100%. The position of the air recirculation flap influences the air flow across the width of the conveyor belt from right to left.

It is particularly preferred that the air circulation circuit has two drying flaps, which are arranged laterally on a first outer side of the drying chamber and laterally on a second outer side of the drying chamber opposite the first side. If the production speed is reduced, the cans are preferably conveyed on one side of the conveyor belt as the cans in the bundle have a lower risk of falling over. This means that the air circulation flaps can also be used to optimize the drying process if the drying device is not fully utilized.

A further preferred embodiment of the drying device is characterized in that the air circulation circuit has an air circulation fan for effecting recirculation, wherein one of the two or more adjustment variables is a rotational speed of the air circulation fan. Preferably, the fluid flow device comprises the recirculation fan.

The recirculation fan can also be provided without the recirculation damper in the recirculation circuit. The air circulation fan is preferably coupled to a fluid outlet and a fluid inlet of the drying chamber. The drying fluid that was applied to the cans can then return to the recirculation fan through the recirculation circuit and from there be fed back into the drying chamber.

It is also preferable that the recirculation fan is fluidically coupled with a fresh air inlet for supplying fresh air.

It is further preferred for the fluid flow device to comprise an exhaust fan for effecting an exhaust air flow from the drying chamber, wherein one of the two or more adjustment variables is a rotational speed of the exhaust fan.

To form the coating, it is advantageous to adjust a circulating air flow and an exhaust air flow in such a way that the coating can be produced with high quality and high energy efficiency. The greater the exhaust airflow from the drying chamber, the higher the heating capacity required to control the temperature of the drying fluid. On the other hand, a drying fluid that is circulated too often can have inadequate properties that reduce the quality of the coating.

It is further preferred for the drying device to comprise a conveying device for conveying the cans through the drying chamber at a conveying speed, wherein one of the two or more adjustment variables is the conveying speed.

Furthermore, it is preferred for a chamber temperature to be adjustable in the drying chamber, in particular with the fluid flow device and/or a heating unit, wherein one of the two or more adjustment variables is the chamber temperature.

The chamber temperature can also be specified as a range. The heating unit can be a heating coil or a gas burner, for example. It is further preferred for one of the two or more adjustment variables to be can temperature. The can temperature can be determined using an infrared sensor, for example. This infrared sensor is preferably coupled with the control unit so as to transmit signals.

A further preferred embodiment of the drying device is characterized in that the cans can be conveyed through the drying chamber with a transport density, characterizing a number of cans per time unit, and one of the two or more adjustment variables is the transport density. The drying device preferably comprises a conveyor belt with which the cans are conveyed through the drying chamber.

It is also preferred for the can parameter to be a can size, a can shape, and/or a coating type of the coating applied in the cavity of the can. The can size can be, for example, a can length, a can diameter, a ratio of the can length to the can diameter, and/or a can volume. Furthermore, it is preferred that the at least one coating parameter is a pore density.

According to a further aspect, the task mentioned at the beginning is solved by a method for forming a coating with at least one defined coating parameter in a cavity of a metal can, in particular a beverage or food can, in particular with a drying device according to one of the embodiments described above, comprising the steps: Applying a drying fluid to the can and controlling two or more adjustment variables of adjustment means in dependence on at least one can parameter such that the coating is formed with the at least one defined coating parameter.

Controlling the two or more adjustment variables can also mean adjusting and/or regulating.

Furthermore, it is preferred for the method to comprise the step of: Adjusting an adjustment value for each of the two or more adjustment variables, whereby the adjustment values are defined as a function of a defined can parameter. In addition, the method may comprise the step: Adjusting the position of a nozzle unit so that a clear height between the nozzle unit and the cans can be set.

The method and its possible embodiments have features or method steps which make them particularly suitable for use in a drying device and its embodiments.

For further advantages, embodiment variants and embodiment details of the method and possible embodiments, reference is also made to the previous description of the corresponding features and embodiments of the drying device.

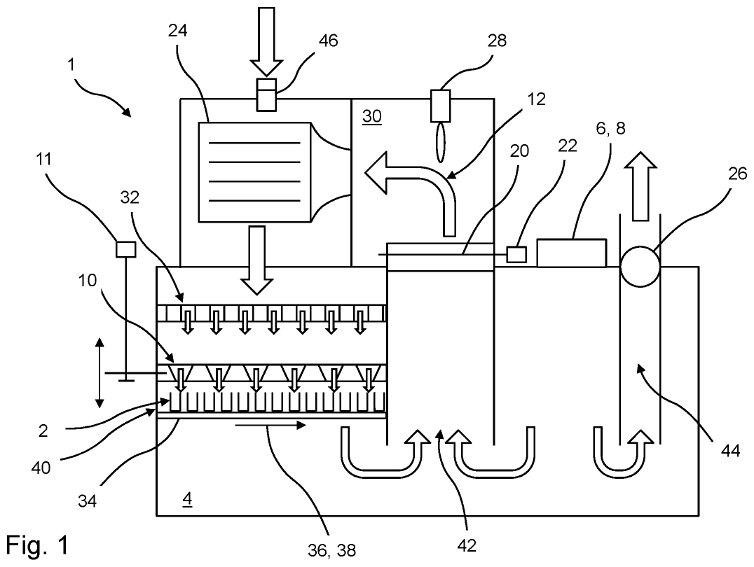

FIG. 1 shows a drying device 1 for forming a coating with at least one defined coating parameter in cavities of metal cans 2. The drying device 1 comprises a drying chamber 4, through which the cans 2 can be moved and dried. FIG. 1 also shows the fluid flows inside and outside the drying device 1 using wide arrows.

The drying device 1 also comprises several adjustment means, such as a nozzle unit 10, an air circulation flap 20, 20′, an air circulation fan 24, an exhaust fan 26, and a conveying device 34. The cans 2 are conveyed by a conveying device 34 in the conveying direction 36 at a conveying speed 38. The adjustment means can each be adjusted with adjustment parameters.

The drying device 1 also comprises the control unit 6, which is coupled to the adjustment means so as to transmit signals. The control unit 6 also comprises a memory unit 8, in which an adjustment value for at least one defined can parameter for adjusting the at least one coating parameter is stored for each of the two or more adjustment variables.

The nozzle unit 10 is also arranged in the drying chamber 4. The nozzle unit 10 comprises a large number of nozzles through which the drying fluid 12 can pass. A perforated plate 32 is arranged vertically above the nozzle unit 10 for better distribution of the drying fluid 12 above the nozzle unit 10. The cans 2 are conveyed under the nozzle unit 10 so that the drying fluid 12 passing through the nozzle unit 10 hits the cans 2.

The nozzle unit 10 is coupled to a nozzle actuator 11. The nozzle actuator 11 can be used to adjust the position of the nozzle unit 10 in a vertical direction. The nozzle unit 10 is coupled to the nozzle actuator 11 by means of a gearbox. This means that a better coating can be achieved on different cans.

The drying fluid 12 circulates in an air circulation circuit 18, among other things, so that better energy efficiency is achieved. Part of the drying fluid 12 can escape from the drying chamber 4 through the exhaust duct 44 by means of the exhaust fan 26.

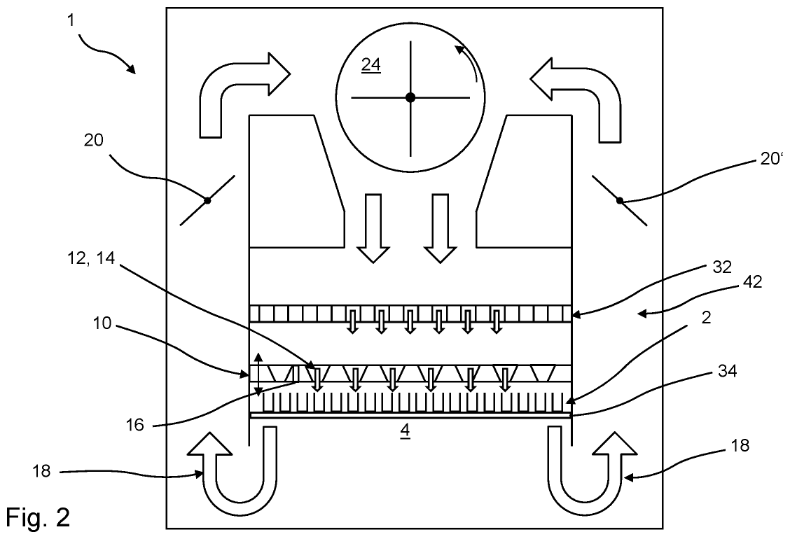

As shown in FIG. 2, the drying fluid 12 passes through the nozzle unit 10 at a drying fluid speed 14. The nozzle unit 10 further comprises a pressure loss sensor 16 for determining a pressure loss between a nozzle inlet and a nozzle outlet of the nozzle unit 10 in order to determine the drying fluid velocity 14.

The drying device 1 also comprises two air circulation flaps 20, 20′ in the air circulation circuit 18, both of which are shown in FIG. 2. The recirculation air flaps 20, 20′ are coupled to a recirculation air actuator 22 shown in FIG. 1, such that the recirculation air volume can be adjusted with the recirculation air actuator 22. Furthermore, the recirculation air flow is adjusted with the recirculation fan 24. The recirculation fan 24 is also fluidically coupled to a fresh air duct 46, which also has a flap. A heating chamber 30 is arranged in front of the circulating air fan 24 in the direction of fluid flow, within which a gas burner 28 heats the drying fluid 12.

The cans 2 are conveyed from a can inlet 40 into the drying chamber 4. On a side of the drying chamber 4 opposite the can inlet 40, the cans 2 exit the drying chamber 4 again.

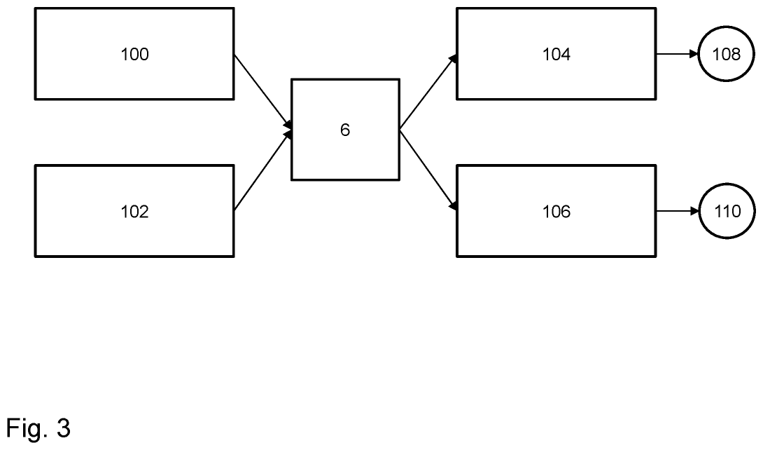

FIG. 3 shows the data processing of the control unit 6. The at least one can parameter 100 and the at least one coating parameter 102 act as input variables for the control unit 6. A correlation is stored in the control unit 6, which determines or stores adjustment values for the adjustment variables on the basis of the at least one can parameter 100 and the at least one coating parameter 102. The coating parameter 102 can also be a constant.

In the present case, the adjustment variables are the positions 104 of the nozzle unit 10 and the chamber temperature 106. Based on the can parameter 100 and the coating parameter 102, the control unit 6 determines that the position 104 of the nozzle unit has the first adjustment value 108, for example a second position, and the chamber temperature 106 has the second adjustment value 110, for example 185° C.

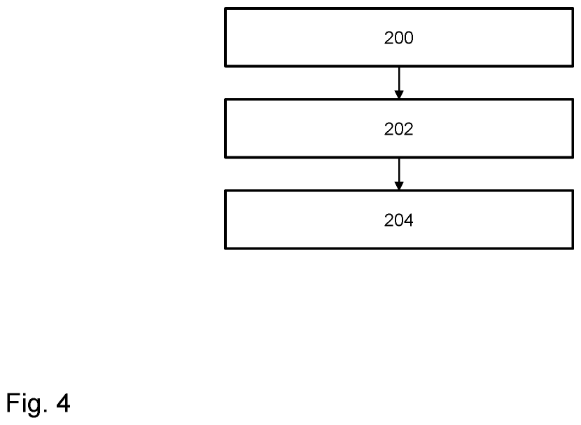

FIG. 4 shows a schematic process. In step 200, a can parameter 100 is provided. The can parameter 100 can, for example, be a can volume, such as 0.5 liters. In step 202, the can 2 is exposed to the drying fluid 12. In step 204, the two or more adjustment variables 104, 106 are controlled as a function of the can parameter 100 such that the coating is formed with the at least one defined coating parameter 102.

With the drying device 1 described above and the corresponding process, it is possible to produce cans 2 with a high-quality coating of the cavity. This increases the storage time of beverages and food in the cans. Furthermore, the quality of the can contents can be increased as the coating provides better protection.

### REFERENCE SYMBOLS

1 drying device
2 cans
4 drying chamber
6 control unit
8 memory unit
10 nozzle unit
11 nozzle actuator
12 drying fluid
14 drying fluid speed
16 pressure loss sensor
18 air circulation circuit
20, 20′ air circulation flap
22 air circulation actuator
24 recirculation fan
26 exhaust air fan
28 gas burner
30 heating chamber
32 perforated plate
34 conveyor
36 conveying direction
38 conveying speed
40 can input
42 recirculation duct
44 exhaust air duct
46 fresh air duct
100 can parameter(s)
102 coating parameter(s)
104 first adjustment variable
106 second adjustment variable
108 first adjustment value
110 second adjustment value

1. A drying apparatus for forming a coating with at least one defined coating parameter in a cavity of a metallic can, the drying device comprising:
a drying chamber through which the cans can be moved;
adjustment means having two or more controllable adjustment variables, wherein the adjustment means are arranged and adapted to adjust the at least one coating parameter of the coating; and
a control unit which is coupled to the adjustment means so as to transmit signals and which is set up to control the two or more adjustment variables as a function of at least one can parameter in such a way that the coating is formed with the at least one defined coating parameter.

2. The drying device according to claim 1, further comprising:
a memory unit coupled to the control unit, in which an adjustment value for at least one defined can parameter for adjusting the at least one coating parameter is stored for each of the two or more adjustment variables; and
wherein the control unit is arranged to adjust the respective one adjustment value for the two or more adjustment variables when a can is produced with the at least one defined can parameter.

3. The drying device according to claim 1, wherein
the adjustment means comprise or are a fluid flow device for applying a drying fluid to the cans, and
the fluid flow device can be controlled with at least one of the two or more adjustment variables.

4. The drying device according to claim 1, wherein
the fluid flow device comprises a height-adjustable nozzle unit, wherein one of the two or more adjustment variables is a position of the nozzle unit so that a clearance height between the nozzle unit and the cans is adjustable.

5. The drying device according to claim 1, further comprising:
a nozzle actuator coupled to the nozzle unit, which is arranged and designed to adjust the position of the nozzle unit.

6. The drying device according to claim 1, wherein
one of the two or more adjustment variables is a drying fluid speed of the drying fluid flowing out of the nozzle unit.

7. The drying device according to claim 1, further comprising
at least one pressure loss sensor for determining a pressure loss between a nozzle inlet and a nozzle outlet of the nozzle unit in order to determine the drying fluid speed.

8. The drying device according to claim 1, further comprising
an air circulation circuit for recirculating the drying fluid in the drying chamber with an air circulation flap coupled to an air circulation actuator,
wherein one of the two or more adjustment variables is a position of the air recirculation flap.

9. The drying device according to claim 1, wherein
the air recirculation circuit has a recirculation fan for effecting recirculation, wherein one of the two or more setting variables is a rotational speed of the recirculation fan.

10. The drying device according to claim 1, wherein
the fluid flow device comprises an exhaust fan for effecting an exhaust air flow from the drying chamber, wherein one of the two or more adjustment variables is a rotational speed of the exhaust fan.

11. The drying device according to claim 1, further comprising
a conveying device for conveying the cans through the drying chamber at a conveying speed, wherein one of the two or more adjustment variables is the conveying speed.

12. The drying device according to claim 1, wherein
a chamber temperature can be set in the drying chamber, wherein one of the two or more adjustment variables is the chamber temperature.

13. The drying device according to claim 1, wherein
the cans can be conveyed through the drying chamber with a transport density, characterizing a number of cans per unit time, and one of the two or more adjustment variables is the transport density.

14. The drying device according to claim 1, wherein
the can parameter is a can size, a can shape and/or a lacquer type of the coating applied in the cavity of the can.

15. The drying device according to claim 1, wherein
the at least one coating parameter is a pore density.

16. A method for forming a coating with at least one defined coating parameter in a cavity of a metal can, in particular with a drying device according to claim 1, the method comprising:
applying a drying fluid to the can; and
controlling two or more adjustment variables of adjustment means in dependence on at least one can parameter such that the coating is formed with the at least one defined coating parameter.
